(19) United States
(12) Patent Application Publication
(10) Pub. No.: US 2022/0253776 A1
(43) Pub. Date: Aug. 11, 2022

(54) AUTOMATICALLY DISCOVERING DATA TRENDS USING ANONYMIZED DATA

(71) Applicant: COUPA SOFTWARE INCORPORATED, San Mateo, CA (US)

(72) Inventors: Arjun Ramaratnam, Newark, CA (US); Vincent Toesca, San Francisco, CA (US); Kiran Ratnapu, San Jose, CA (US); Brent Sisson, Castro Valley, CA (US)

(21) Appl. No.: 17/585,191

(22) Filed: Jan. 26, 2022

Related U.S. Application Data
(60) Provisional application No. 63/147,976, filed on Feb. 10, 2021.

(51) Int. Cl. G06Q 10/06; G06Q 10/08; G06V 30/19

(52) U.S. Cl. CPC G06Q 10/06315; G06Q 10/08; G06V 30/19107; G06V 30/19193; G06V 30/19173

(57) ABSTRACT

A computer-implemented method of executing a programmed spend management computer system. The computer system comprises a data pre-processor that is communicatively coupled to a plurality of the application instances and accesses historic transaction data from any of the instances and thereby has access to a large community of data across all tenants. The data pre-processor is programmed to normalize transaction descriptions and determine line spend values, unit price values, quantity values, and buyer country data for a plurality of commodities, and to store the data in item sets in digital storage. A statistical processor is coupled to the digital storage to access the item sets and executes statistical calculation on the item sets to generate pricing insight data. Pricing insights and/or prescriptions are generated automatically under stored program control and provided to a presentation processor for output to and/or rendering to an end-user device.

### BENEFIT CLAIM

This application claims the benefit of provisional application 63/147,976, filed Feb. 10, 2021, the entire contents of which is hereby incorporated by reference for all purposes as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2020-2021 Coupa Software Incorporated.

### TECHNICAL FIELD

One technical field of the present disclosure is computer-implemented methods of determining consistent descriptions of items in procurement transactions. Another technical field is computer-implemented methods of using machine learning models to determine statistical trends in changes of attributes of items. Still another technical field is computer-generated recommendations for changing the configuration of a procurement system.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Large-scale purchase processing, sourcing events, and other enterprise procurement activities can be managed using computer-implemented application server systems, typically hosted as software as a service (SaaS) using network resources. In one mode of deployment, multiple different computer servers or cloud computing instances each executes an instance of an e-procurement application or spend management system. The computers of a large number of different enterprises or entities connect to the spend management system instances to create sourcing events, authorize purchases of goods or services, receive invoices and process invoices through automated workflows, and other tasks.

Large numbers of buyer computers of buyer entities and supplier computers of suppliers may connect to the application instances. These computers may interoperate to complete thousands of transactions per enterprise per year, creating tens of millions of data records among them to represent the transactions. One buyer may wish to know what price was paid by multiple other buyers for the same commodity from the same supplier, or different suppliers, in about the same quantity for delivery at about the same time. Unfortunately, different buyers and suppliers often use different descriptions for the same commodity in different transactions. Therefore, deriving meaning from the mass of community data for transactions, such as price trends, is extremely difficult to execute on an automated basis using stored program computers.

Consequently, there is an acute need in this industrial field to solve an important technical problem using technical means. The problem is how to determine, automatically and programmatically using stored program digital computers, that a record for one particular transaction actually involves the same or similar commodity as in many other transactions, and to use the resulting data for statistical comparisons to yield new data that is useful in automatic contract negotiation, other transactions, or changes in the configuration of a SaaS-based spend management system.

### SUMMARY

The appended claims may serve as a summary of the invention.

### BRIEF DESCRIPTION OF THE DRAWINGS

In the drawings:

FIG. 1 illustrates a computer system showing the context of use and principal functional elements with which one embodiment could be implemented.

FIG. 2A illustrates a process of automatically comparing transaction data and executing changes in a spend management system based upon the comparisons.

FIG. 2B illustrates a process of implementing certain steps of FIG. 2A.

FIG. 3A illustrates an example architecture of a machine learning system that can be used to solve aspects of steps of FIG. 2A, FIG. 2B.

FIG. 3B illustrates example sub graphs of terms that may be used in parts of the extraction steps of FIG. 2B.

FIG. 4 illustrates an example display device with graphical user interface and showing example prescriptions.

FIG. 5A illustrates an example display device with graphical user interface showing item price variance data and related values.

FIG. 5B illustrates an example display device with graphical user interface showing example item categories.

FIG. 5C illustrates an example display device with graphical user interface showing example variance analysis displays for a single commodity.

FIG. 5D illustrates an example display device with graphical user interface showing example historic transaction data.

FIG. 6 illustrates a computer system with which one embodiment could be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program a computer to implement the claimed inventions, at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

Embodiments are described in sections below according to the following outline:
1. General Overview
2. Structural & Functional Overview
3. Automatically Extracting Attributes of Items in Spend Management Community Data
4. Example Prescriptions
5. Examples of Processing Scale, Result Data, and Criteria for Price Comparison
6. Implementation Example—Hardware Overview

### 1. General Overview

The fundamental goal of users of all spend management systems is to ensure that an enterprise is paying the least amount for a product or service that meets the requirements of the enterprise. While price is only one element of the overall choice to buy from a given supplier, once all other aspects are accounted for, price is the final element for which buyers optimize. But to conduct accurate price comparison, consistent item descriptions must be derived from transaction data to ensure that historic transactions are comparable. Embodiments of this disclosure solve the technical problem of how to determine, automatically and programmatically using stored program digital computers, that a record for one particular transaction actually involves the same or similar commodity as in many other transactions, and to use the resulting data for statistical comparisons to yield new data that is useful in automatic contract negotiation, other transactions, or changes in the configuration of a SaaS-based spend management system.

Embodiments may be employed using SaaS spend management systems that are deployed using multiple different computer servers or cloud computing instances to execute an instance of an e-procurement application or spend management system. The computers of a large number of different enterprises or entities connect to the spend management system instances to create sourcing events, authorize purchases of goods or services, receive invoices and process invoices through automated workflows, and other tasks. Large numbers of buyer computers of buyer entities and supplier computers of suppliers may connect to the application instances. These computers may interoperate to complete thousands of transactions per enterprise per year, creating tens of millions of data records among them to represent the transactions. Thus, embodiments are useful in large-scale systems in which real-time response is needed to assess tens of millions of records of transaction data, a scale that is not possible to achieve using human resources.

In an embodiment, an item similarity framework for pricing, implemented using stored program instructions, allows a buyer computer to assess thousands to millions of transactions and modify other programmatic interactions with suppliers in ways not previously possible. In an embodiment, item similarity instructions execute on computers having access to item information from a large transaction dataset derived from interactions among large numbers of supplier computers and buyer computers in a community of different entities or enterprises, including entities that are direct competitors of one another.

Embodiments may be deployed in a multi-tenant spend management system in which data of one entity is logically isolated from and inaccessible to a second, different entity, yet data that all entities create in transactions is available for item similarity assessments. Therefore, the item similarity framework of this disclosure can execute to standardize item information from any source and extract industry trends and patterns in buying that would not otherwise be identifiable. Furthermore, the item similarity framework can automatically generate and transmit prescriptions or recommendations to entities. Recommendations can be used for decision support including benchmarking against peers who are using other suppliers, contract negotiation, cost control, spend analysis to detect over-spending, and other functions; the recommendations, prescriptions and other output of embodiments consists of data not previously available and automatically generated programmatically using the processes described herein.

One embodiment may be structured according to the following principles and concepts.

Item Similarity. Good and services being purchased can only be meaningfully compared if they are similar enough to each other to warrant comparison. For example, a buyer computer that is comparing the price of a luxury-class item to an economy-class item will not obtain good results. The items may have many of the same basic attributes, but the values for the attributes are so different that the comparison is unhelpful. For items to be similar enough for comparison, certain critical attributes must have consistent values. Other attributes that do not materially affect price can vary.

Item Attributes. Item attributes are the collections of variables that describe some base category of items. The base item can be described by a detailed level of a commodity taxonomy. For example, the UNSPSC code 26111702 may specify Alkaline Batteries. Attributes for this category may include Manufacturer (e.g., DURACELL, ENERGIZER), Voltage (1.5V, 2.0V), Size (AA, AAA, D, C), and warranty period. By investigating each category in a taxonomy, the attributes that describe the item can be determined. Then, using sample transactions, the possible values for each attribute for a purchased item can be determined. Next, critical attributes can be determined, as well as attributes that do not affect price.

Taxonomy. In an embodiment, a taxonomy is a classification hierarchy that allows for high-level grouping of items being purchased, to enable spend analysis and narrow possible attributes.

Attribute Library. The collection of all attributes and known values for each of the categories in the taxonomy, used to compare a new transaction and determine its similarity to the existing population of spend data.

Critical Attributes. The attributes that have an impact on the price of the item and are important for establishing effective similarity.

In one embodiment, the disclosure provides a programmed computer system using data analysis, classification, aggregation and statistical analysis to automatically generate and provide, to buyer computers or accounts, pricing trends that are discovered automatically in the procurement, sourcing and purchase processes of items or commodities based on anonymized, aggregated data. Community data is anonymized, so that specific buyer computers, buyer accounts, or buyer entities are not known to one another. Community data is aggregated, so that similar transactions are grouped for comparison.

Generally, items in historic transaction data are classified according to a specified taxonomy or hierarchy of items. Items can be classified based upon an association with a larger group of items that is within a particular taxonomy class. Or, individual attribute values of line items in historic transaction data may be automatically correlated to taxonomy categories. Or, a combination of the foregoing classifications can be used to associate an item with a taxonomy category. In a first step, the system is programmed to inspect all transactions that have been digitally stored in distributed storage from de-identified execution instances or tenants of a multi-tenant, cloud-based spend management system. Furthermore, the system is programmed to:

A. Cluster transactions by identical or similar description using machine learning techniques;

B. Count all occurrences of spend transactions;

C. Count the total USD-denominated (organic or converted) amounts of such spend transactions;

D. Group transactions by time periods/series (e.g., month);

E. Group transactions by industries;

F. Group transactions by geographies.

In an embodiment, after data is collected, aggregated, classified, divided into line items, and sorted into line item data points, statistical analysis can be applied to the data points to identify those pricing intervals that are useful to present to an end user, and prescriptions or action triggers may be generated.

“Prescriptions” and “action triggers” include, for example, generating deep links directly into specified pages or functions of the spend management system so that a particular user account can immediately execute a specified action. A prescription also may include a human-readable notification that includes one or more hyperlinks which, when selected, cause retrieving or linking to the specified pages or functions.

In one embodiment, a computer system according to the present disclosure is implemented in the context of a distributed, multiple instance, multiple tenant, spend management computer system with which a plurality of buyer computers and supplier computers are communicatively coupled and execute transactions such as purchase requisitions, supply of goods, invoicing, and related electronic documentation. The computer system comprises a data pre-processor that is communicatively coupled to a plurality of the application instances and accesses historic transaction data from any of the instances and thereby has access to a large community of data across all tenants, including competitors of one another. The data pre-processor is programmed to normalize transaction descriptions and determine line spend values, unit price values, quantity values, and buyer country data for a plurality of commodities, and to store the data in item sets in digital storage. “Normalize,” in this context, can refer to transferring values of attributes from source data into consistent classifications or into a taxonomy that supports similarity grouping and comparison. In some embodiments, the OpenTag methodology can be used to extract consistent classes of data from a plurality of different data sources that store similar data in different record formats, and to form a graph representation of the data in memory or storage via machine learning models, clustering techniques, and attribute extraction, which can result in creating and storing consistent names or labels for suppliers or commodities that have different names or labels in the source data.

A statistical processor is coupled to the digital storage to access the item sets and executes statistical calculation on the item sets to generate pricing insight data, for example, a distribution of all prices in contracts or transactions for a specified commodity across the entire community. The statistical processor may receive input from a filter processor to filter out certain transactions, suppliers, commodities, or other data attributes before executing the statistical calculations. Pricing insights and/or prescriptions are generated automatically under stored program control and provided to a presentation processor for output to and/or rendering to an end-user device.

In one embodiment, a programmed process of executing the computer system includes identifying contracts that are up for renewal; collecting spend data for a supplier; collecting supplier metadata such as risk, diversity, or other attributes; executing item coverage and pricing analysis for the supplier; preparing a supplier scorecard; and signaling a user account or buyer computer to negotiate a new contract.

In another embodiment, a plurality of sources of customer buying data such as data catalogs, freeform customer buying data, punchouts, and external sources are coupled to a classification step, which executes machine learning algorithms to classify the data according to an item taxonomy and an item attribute library, based upon training from community transactions at large scale. Output of the classification step is provided to an item attribute step to extract attributes of items that have a material effect on price. Output from item attribute extraction is provide to an item similarity grouping and price comparison step, which outputs sets of items that are similar and comparative pricing data, such as distributions of prices. The output data is transmitted to a user interface for consumption there, and/or used for automatically generating prescriptions concerning the output data.

### 2. Structural & Functional Overview

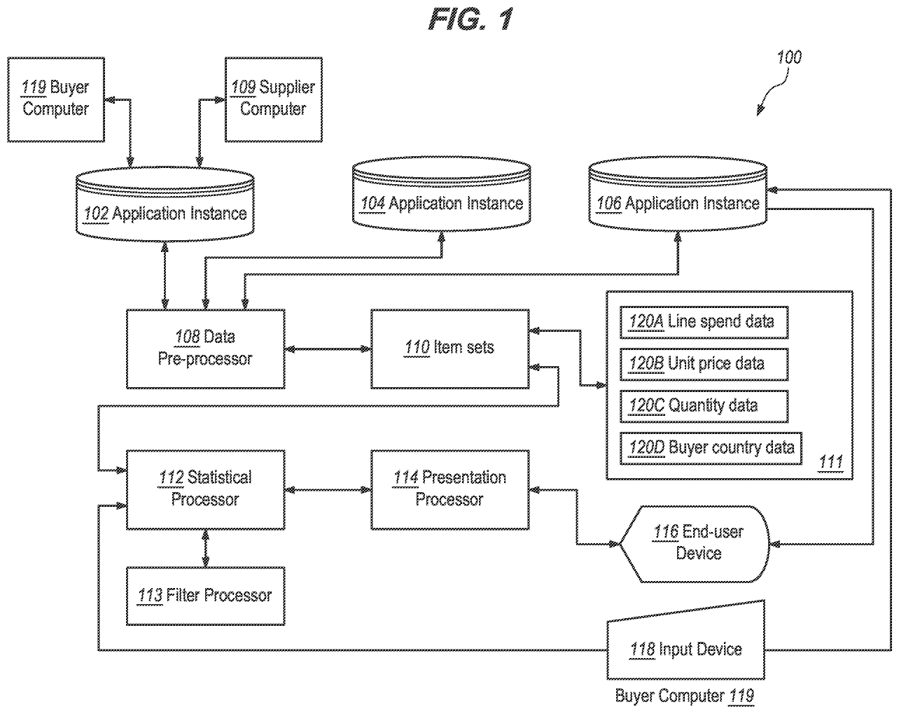

FIG. 1 illustrates a distributed computer system showing the context of use and principal functional elements with which one embodiment could be implemented.

In an embodiment, a computer system 100 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity or mathematical algorithm, has no support in this disclosure and is erroneous.

Computer system 100 is organized and programmed using data analysis, classification, aggregation and statistical analysis to help buyer computers receive automatically calculated pricing trend data and other digital data relevant to the procurement, sourcing and purchase process of items based on anonymized crowdsourced data. In the example of FIG. 1, computer system 100 comprises a plurality of application instances 102, 104, 106, each of which may comprise a distinct instance of the same application program. An example is a spend management system. The instances 102, 104, 106 may be termed “customer instances” when they are associated with entities that have a customer relationship to a service provider that owns or operates computer system 100. Instances 102, 104, 106 may execute on the same computer, different computers, different virtual computing instances of a private or public cloud datacenter or using other computing equipment. Three (3) instances are shown for the purpose of illustrating a clear example; however, other embodiments may have more or fewer instances of the application.

To create, complete, manage, and analyze spend transactions, a plurality of buyer computers represented by buyer computer 119 and a plurality of supplier computers 109 are communicatively coupled to each of the application instances 102, 104, 106. FIG. 1 shows two examples of such computers, but practical embodiments may involve tens of thousands of buyer computers 119 and supplier computers 109 in a large community of computers, accounts, and entities that execute transactions of different types. Examples of transactions include requisitions or purchase orders, supply contracts, invoices, and sourcing events.

Application instances 102, 104, 106 are communicatively coupled directly or indirectly via one or more network links to a data pre-processor 108, which interoperates with item sets 110, each comprising, for example, an association or record 111 of digitally stored data such as line spend data 120A, unit price data 120B, quantity data 120C, and buyer country data 120D. In other items, records 111 may comprise data, values, columns or attributes other than as shown in FIG. 1. Records 111 may be obtained from a plurality of different data sources to which the application instances 102, 104, 106 are coupled, via individual databases, shared multi-tenant data storage, or external sources; example data sources include data catalogs, punchouts, freeform data, websites, or other external sources accessed via database calls, database services or primitives of programming languages, API calls, or application-specific calls.

Data pre-processor 108 is programmed to execute data extraction operations as further described herein. The item sets 110 are accessible to a statistical processor 112, which interoperates with a filter processor 113 to statistically analyze selected records 111 and output statistical results and records to presentation processor 114. The presentation processor 114 is programmed to receive the statistical results and records, to format data for presentation based on attributes of an end-user device 116, and to generate presentation data capable of interpretation or rendering at the end-user device. For example, presentation processor 114 may be programmed to receive calls from the statistical processor 112 and to output dynamically generated HTML, code for rendering in a browser of the end-user device 116.

Each of the application instances 102, 104, 106 contains or is associated with large-scale datasets. In some embodiments, instances 102, 104, 106 comprise or are communicatively coupled to a relational database or other data storage repository. Datasets for transactions may be organized in relational tables. Example rows of a spend management table may include: Item A1|Total Line Item Spend AA1|Unit Price AAA1; Item A2|Total Line Item Spend AA2|Unit Price AAA2; . . . Item An|Total Line Item Spend AAn|Unit Price AAAn. In one embodiment, data pre-processor 108 is programmed to collect, from the application instances 102, 104, 106, and classify transaction data information pertaining to items, quantity, unit of material, unit price and total price per line item using a common taxonomy, across multiple segregated accounts for the purpose of anonymized and cleansed data analysis. Pre-processing may include attribute extraction, de-identification, classification, and aggregation.

Data pre-processor 108 also may be programmed to sort the classified item data or commodity data in multiple tables or indices. Data pre-processor may implement a supervised machine learning model for automatic classification of input historic transaction data based upon previous training using a labeled training dataset in which similar transaction spend lines have been labeled with taxonomy classes that are correct for items in the spend lines, although the specific item description in different spend lines may be different.

In an embodiment, a clustering model and algorithms execute to group item data based on the item description using a common ontology by applying semantic analysis. In an embodiment, in item sets 111, item attributes are sorted in sub-arrays. Item sets 111 may comprise tables in a relational database and elements 120A, 120B, 120C, 120D may comprise attributes of a single row in a table. For example, one item set 111 may comprise a row that represents a historic transaction for purchase of AAA batteries. For that transaction and row, line spend data 120A may represent “USD10,000”. The unit price data 120B may comprise “USD10”. The quantity data 120C may comprise “1,000”. The buyer country data 120D may comprise “USA”. Each represent attributes of the transaction. These values enable assessment of bulk discounts and other differentiators of transactions for purpose of price variance. The specific labels for elements 120A, 120B, 120C, 120D have been determined to be relevant for price variance analysis across a large number of different commodities and taxonomy categories.

An input device 118 may be part of end-user device 116, the combination of which comprises a buyer computer 119. A large number of different buyer computers 119 may be communicatively coupled to different application instances 102, 104, 106.

The input device 118 may be communicatively coupled to statistical processor 112 and may provide an input signal, request, or command to obtain automatically generated trend data. In an embodiment, based on a user-driven request or a machine command, statistical processor 112 is programmed to query item sets 110 to retrieve pricing data per item, and optionally per region or industry. The statistical processor 112 also is programmed to apply statistical analysis, in real time in response to the request or command, to the data to output data such as a pricing distribution to presentation processor 114. Output data may include Gaussian indicators and signals, trendline points, the results of predictive analytics, or other values.

In an embodiment, filter processor 113 is programmed to apply one or more filters to the item sets 110 to alter the input and therefore change the output data that is sent to presentation processor 114. Filter criteria may be user-supplied via input device 118 or retrieved from configuration files or other machine sources.

In an embodiment, statistical processor 112 is programmed to apply statistical calculations to transaction data to analyze the average, median, mode, min, max, standard deviation, variance, top quartile, bottom quartile, trend lines and volatility of the item-based pricing data. Analysis can include calculating trend lines. Quartile, in this context, refers to tranches of customers within four (4) regions of pricing in a normal distribution. The position of a buyer computer within the top quartile would mean that the buyer account or its entity are obtaining the lowest price for the specified commodity. Or, the position of the buyer computer within the distribution as a whole could signal that the present is a good time, or poor time, in which to initiate a new contract at the median price or a price near the median price.

Statistical processor 112 also may be programmed to generate prescriptions, or action triggers, to modify the configuration of one of the application instances 102, 104, 106 or to help users make optimal pricing decisions. Prescriptions or action triggers may be output to the end-user device 116 and may comprise deep links into specified pages or functions of the application instances 102, 104, 106, and/or changes in configuration values or text recommendations, for example.

The initial execution of data preprocessor 108 can be triggered in several different ways. For example, data preprocessor 108 may be programmed as a cron job to run overnight or at other specified periods based upon historic transaction data as updated to the completion of the preceding day. Or, data preprocessor 108 may execute periodically during a business day and may process transaction data in real time as transactions flow through the application instances 102, 104, 106 between different buyer computers and supplier computers. Similarly, execution of statistical processor 112 can be triggered in several different ways. For example, a user account or buyer computer 119 may start the creation of a new requisition that identifies a supplier, and in response, the statistical processor 112 may execute to deliver prescriptions or recommendations of supplier.

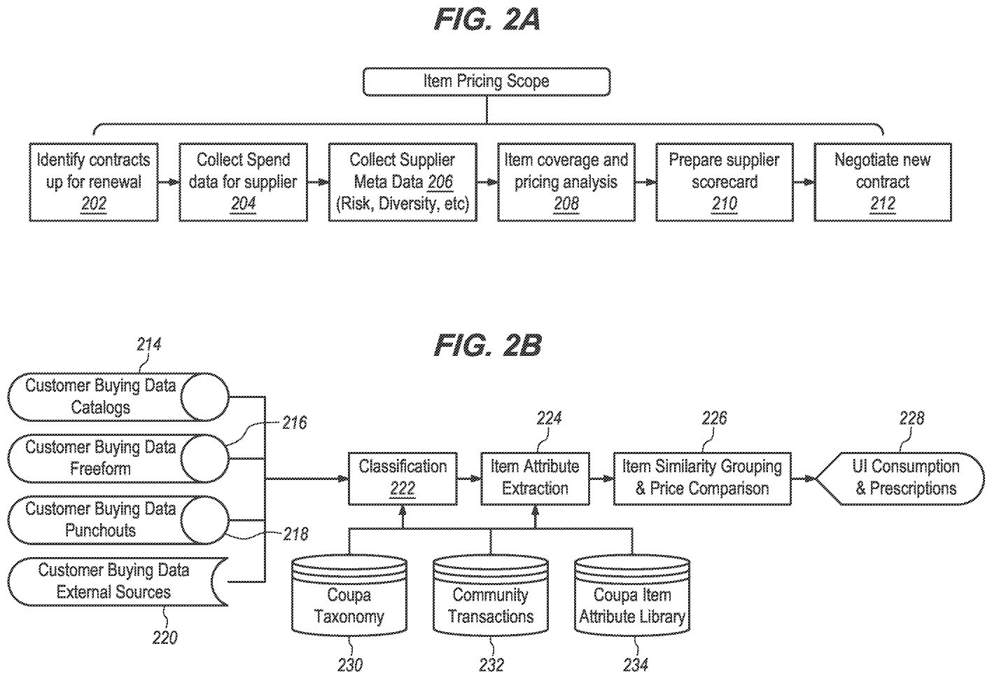

FIG. 2A illustrates a process of automatically comparing transaction data and executing changes in a spend management system based upon the comparisons. FIG. 2B illustrates a process of implementing certain steps of FIG. 2A. FIG. 2A, FIG. 2B and each other flow diagram herein is intended as an illustration at the functional level at which skilled persons, in the art to which this disclosure pertains, communicate with one another to describe and implement algorithms using programming. The flow diagrams are not intended to illustrate every instruction, method object or sub-step that would be needed to program every aspect of a working program, but are provided at the same functional level of illustration that is normally used at the high level of skill in this art to communicate the basis of developing working programs.

Referring first to FIG. 2A, in the context of FIG. 1, in one embodiment, at block 202, an application instances 102, 104, 106 may be programmed to execute a routine to identify one or more supply contracts that are up for renewal. For example, application instance 106 may be programmed to execute a nightly cron job or other programmed routine that searches a database table of existing purchase contracts to identify expiration dates occurring within 10 to 30 days in the future, and to output a list of such contracts using a dynamically generated graphical user interface that is driven to end-user device 116. The output also may comprise a signal to statistical processor 112 to execute pricing analysis on all available item sets 110. In response, statistical processor 112 may be programmed at block 204 to collect spend data of the entity associated with application instance 106 in relation to a particular supplier that is a party to a contract in the list.

At block 206, statistical processor 112 may be programmed to collect metadata concerning the specified supplier, such as risk of default in performance, owner or employee diversity, or other values that describe the specified supplier.

At block 208, statistical processor 112 may be programmed to execute item coverage and pricing analysis. Item coverage, in this context, refers to determining what items the supplier is capable of supplying or has supplied in past transactions across the community. Pricing analysis refers to determining relationships between present contract pricing of the buyer computer and the supplier entity and prices that the supplier has offered to other buyers in other transactions in the community.

At block 210, statistical processor 112 may be programmed to generate a supplier scorecard, which may comprise a set of statistical data concerning the supplier that has been generated or collected as output from block 208. Block 210 may comprise organizing the data for presentation using presentation processor 114.

At block 212, the process may conclude by negotiating a new contract. In some embodiments, blocks 202, 212 execute manually rather than automatically.

Item coverage and pricing analysis at block 208 may use the process shown in FIG. 2B. Referring now to FIG. 2B, in one embodiment, item coverage and pricing analysis first comprises executing a data classification operation 222. As input, data classification instructions may receive or have access to customer buying data catalogs 214, freeform customer buying data 216, customer buying data punchouts 218, and/or external sources 220 of customer buying data. Input may also comprise taxonomy data, community transactions data, and an item attribute library. Specific techniques for data classification are discussed in other sections herein.

At block 224, item attribute extraction is executed. Specific techniques for extracting attributes of items are discussed in other sections herein.

At block 226, the process executes item similarity grouping and price comparison. Specific techniques are discussed in other sections herein.

At block 228, prescriptions and other output data are prepared for consumption, for example, in a graphical user interface.

### 3. Automatically Extracting Attributes of Items in Spend Management Community Data

In one embodiment, the data preprocessor 108 is programmed to automatically extract a plurality of attributes of items from transaction data developed on a community basis in the spend management computer system. In particular, embodiments are programmed to identify attributes of items without a priori digitally stored data that describes the attributes; instead, attributes are derived inferentially as transactions are processed. For example, the following input of TABLE 1 can be processed to produce the specified output.

TABLE 1
Extracting item attribute values from product descriptions.

| Sample Input | Sample Output |
|---|---|
| PAPER - Staples Copy Paper, LEDGER-size, | paper {‘Brand’: ‘staples', ‘Type’: ‘copy’, |
| 92/104 US/Euro Brightness, 20 lb., 11″ × 17″, | ‘Size’: ‘11 x 17’, ‘Weight’: ‘20 lb’} |
| 2,500 Sheets/Ct | |
| PEN - BIC Round Stic Xtra-Life Ballpoint Pens, | pens {‘Color’: ‘blk’, ‘Brand’: ‘bic’, ‘Model’: |
| Medium Point, Black Ink, 60/Pack (GSM609- | ‘bic round stic’, ‘Point’: ‘med’, ‘Other’: ‘xtra |
| BLK) | life’} |
| TONER - HP Toner Cartridge, 64X (CC364X), | toner {‘Brand’: ‘hp’, ‘Color’: ‘black’, |
| High Yield, Black | ‘Other’: ‘high yield’} |

In this example, embodiments do not receive attributes for products in advance. Brand, Type, Size, Weight all are attributes of Paper, but the attributes are not known or stored beforehand; instead, the data preprocessor 108 is programmed to automatically develop such a classification.

In one embodiment, for item attribute extraction at block 224 (FIG. 2B), the OPENTAG (or OpenTag) model is adapted to the problem of extracting attribute for spend line data. OpenTag is described in G. Zheng et al., “OpenTag: Open Attribute Value Extraction from Product Profiles,” published online by “arxiv.org” as paper “1806.01264.pdf” on 6 Oct. 2018. With OpenTag, target attributes and not attribute values for each domain are given as input to the system. The method is useful in extracting new attribute values which were not observed before. A sequence tagging approach known as BIOE tagging is used. A machine learning model is made which will tag each word as BIOE for each attribute simultaneously. Hence only one model will be made. A BiLSTM (Bidirectional Long Short Term Memory) model is used to execute the tagging. BiLSTM models are generally useful in sequential tagging tasks as they take into consideration the sequence of words in text. Conditional Random Fields (CRF) are also used. First a BiLSTM layer is used and then the CRF layer is applied on top of it. For training data, Active Learning is used, since labelled data is needed as a training set, initially a small manually labelled set is used, and then the model iteratively requests other labels of samples from the pool of un-labelled data until a specified criterion is met. The challenge is to design a good query strategy that selects the most informative samples from un-labelled data, given the learner's hypothesis space. This aims to improve the model's performance with as little annotation effort as possible. A Tag Flipping method is used for the Query strategy. In brief, the Tag Flipping method finds the query for which it is most difficult to predict the tags. This method reduces to an extent the amount of labelled training data required.

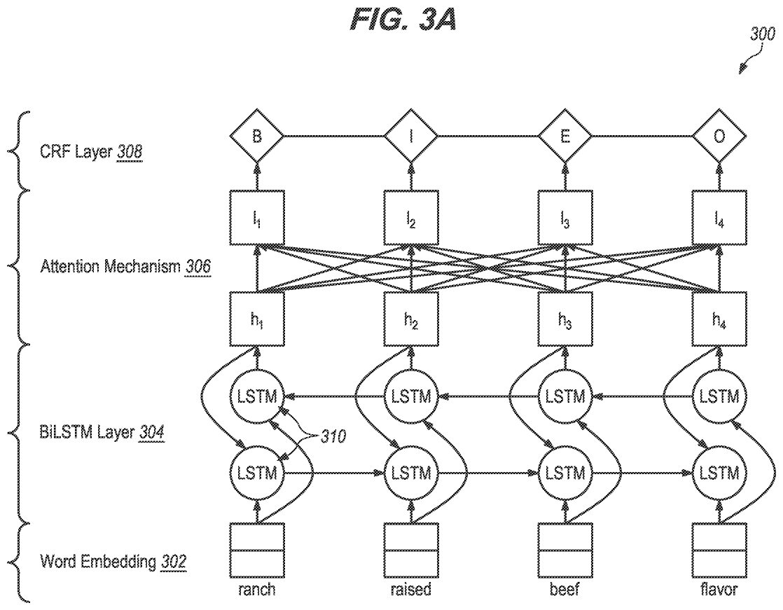

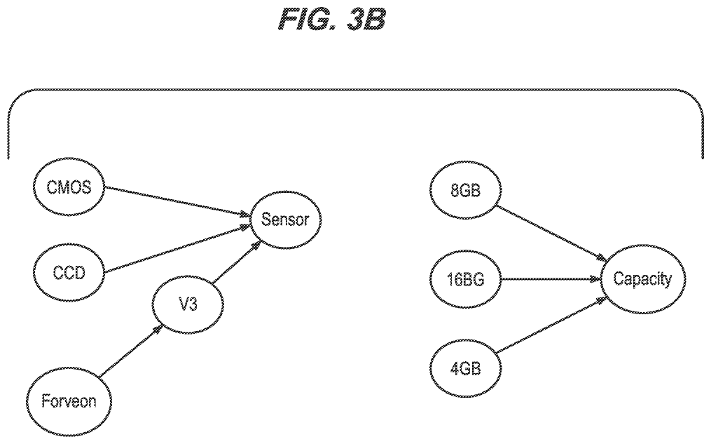

FIG. 3 illustrates an example machine learning model architecture that may be used to implement the OpenTag approach. In an embodiment, a machine learning architecture 300 comprises a word embedding layer 302 coupled to a BiLSTM layer 304, an attention mechanism 306 and CRF layer 308. At its core, the architecture of FIG. 3 uses LSTM models 310 in BiLSTM layer 304. LSTM models capture sequential nature of tokens but overlook the sequential nature of tags. To address this deficiency, in an embodiment, another sequential model such as conditional random fields (CRF) layer 308 is implemented to enforce tagging consistency and extract cohesive chunks of attribute values. An example of such a chunk is a multi-word phrase such as “filet mignon”. At the same time, the models are not structured to execute multi-class classification, because doing so can introduce label scaling problems, requires assuming label independence and a closed world, and other drawbacks. Instead, the models process data as a sequence tagging task. With this approach, implementations are programmed to use the so-called Open World Assumption and discover new values not seen before and label scaling. A tag is associated to a token, and not a specific attribute-value, and, therefore scales well with new values. Embodiments also are capable of discovering multi-word attribute values.

OpenTag builds upon state-of-the-art named entity recognition (NER) systems that use bidirectional LSTM and conditional random fields, but without using any dictionary or hand-crafted features. BiLSTM does not use the sequential nature of the output tags; it only inspects an input sequence of words. The CRF layer 308 accounts for that information. CRF uses the correlation between labels in a neighborhood to make predictions.

In an embodiment, an attention mechanism 306 is implemented. Among the states generated by the BiLSTM layer 304, some states may be more important than others, and determining the important states can help the CRF layer 308 in making predictions. Active Learning is used to reduce the amount of labeled data needed for training the model.

In an embodiment, accuracy in the disclosed model comprises the fraction of words that have been assigned the correct attribute over all the descriptions in the test data set. In an embodiment, hyper parameters of the model comprise batch size; number of RNN units in the LSTM cells; dropout rate in the BiLSTM layer 304; and number of shuffles controlling the amount of data augmentation.

In an embodiment, a Bayesian optimization method may be used to determine a best set of hyper-parameters. For example, the open source “scikit-optimize” package may be used to implement this method.

In an embodiment, a taxonomy 230 (FIG. 2B) of items may be created and stored automatically using a graph clustering technique that is based upon an implementation of S. Raju et al., “A Graph Clustering Approach to Product Attribute Extraction,” Proceedings of the 4th Indian International Conference on Artificial Intelligence, IICAI 2009, Tumkur, Karnataka, India, Dec. 16-18, 2009 (ResearchGate online publication 220888425). In an embodiment, automatically creating the taxonomy 230 generally comprises the steps of graph construction; clustering; extraction of attributes from clusters; and performance evaluation.

A. Graph Construction. In graph construction, the process is programmed to:

Tag the product descriptions for part of speech tags using a NLTK tagger, to obtain noun phrases.

Create and store in memory an undirected graph that may be denoted G=(V,E), where each vertex represents a distinct word in the description collection and each edge (vᵢ,vⱼ,w_{i,j})∈E represents co-occurrences between a pair of words. In an embodiment, two words co-occur if they occur within a noun phrase boundary. The weight of an edge w_{i,j} is the number of co-occurrences between the pair of words represented by vertices vᵢ and vⱼ.

In some embodiments, the attribute and values in the search query may be comma-separated, and commas may serve as noun phrase boundaries rather than POS tags. An example of a comma-separated description is “BIC Stick Ball Pens, Medium Point, 1.2 mm, Black Ink/Clear Barrel, 12/Pk”. Further, in some embodiments, text normalization is executed by stemming, using a rule-based process of stripping suffixes such as “ing”, “ly”, “es”, “s”, from a word. Embodiments may implement special-purpose rules for attributes involving numbers, such as “8½-11 in”.

B. Clustering. In an embodiment, the process is programmed to form clusters such that the collection of words which form the attribute and value occur in the same cluster. Co-occurrence graphs possess the small world property. Graphs built in from product descriptions also follow the co-occurrence property. One embodiment implements the iterative Chinese Whisper (CW) algorithm for clustering, which starts by assigning a separate class to each node. In each iteration, every node is assigned the strongest class in its neighborhood, which is the class having the highest number of edges to the current node. This process continues until no other assignments are possible for any node in the graph, or until a limit on the number of iterations is reached.

In one experimental embodiment, actual clusters formed from items included the following, in which the words which appear first are end words of the attribute in the product description:

[‘hour’, ‘hours’, ‘12/24’]

[‘book’, ‘appointment’, ‘address’, ‘exercise’] this captures the types of “books” possible

[‘pages’, ‘120’, ‘week/2’, ‘280’, ‘192’, ‘150’, ‘200’, ‘112’] stores the type of values which can be associated with “pages”

[‘remover’, ‘staple’, ‘stain’, ‘ultimate’, ‘swingline&reg;’] obtained type of “removers” possible

[‘tissue’, ‘bath’, ‘facial’, ‘mouchoir’, ‘toilet’, ‘toilel’] obtained type of “tissues” possible

[‘mm’, ‘lead’, ‘1.0’, ‘diameter’, ‘inch’, ‘½″×9″’, ‘mm.’] this has clustered size related terms together in a cluster

[‘barrel’, ‘/’, ‘ink’, ‘black’, ‘barrels’, ‘white’, ‘clear’, ‘silver’, ‘red’, ‘brl’] this cluster has some color related terms together, however some data cleaning, like having just “barrel” instead of the “barrels” can improve clustering. Also removing the “/” can be helpful.

C. Extraction of attributes from the clusters. A preliminary observation of example descriptions of items revealed that attributes are usually composed of a maximum of three words. Therefore, in one embodiment, only n-grams up to length “3” are identified as candidate attributes. Furthermore, attribute-value pairs tend to occur together in a single noun compound with a value occurring first followed by the attribute at the head noun. For example, in the phrases “LCD display” and “CMOS Sensor”, the attributes occur at the head noun (display, sensor) and are immediately preceded by values (LCD, CMOS). In an embodiment, the process is programmed to digitally store sub-graphs for attributes. FIG. 3B illustrates sub-graphs for example phrases. In a first example, the head noun is (sensor) and attributes are CMOS, CCD, Forvenon V3, etc.

The process is programmed to next digitally create and store a directed graph, which may be denoted G_{d}: (V_{d}, E_{d}). Each distinct token tⱼ found in the noun phrases constitutes a node i∈V_{d} in the graph. For each token tᵢ preceding tⱼ in a noun phrase, an edge (i, j)∈E is formed from i to j. An edge may comprise an inlink from i and an outlink to j.

Since a head noun is not followed by any other tokens as shown in FIG. 3B, an attribute node should have a larger number of inlinks and a smaller number of outlinks.

Next, the process is programmed to select, from each word cluster C, the node ‘a’ with the maximum difference between inlink and outlinks. Selection may be programmed using the relationship:

a=argmaxᵢ(inlinks(i)−outlink(i)) where i∈C

The token tₐ represented by this node ‘a’ is selected as the attribute if it has a minimum support Sₐ of 0.5. A support may be defined as:

Sₐ=(inlinks(a)−outlinks(a))/inlinks(a)

In an embodiment, no attribute is selected from cluster C if Sₐ<0.5. If all the inlinks to the node ‘a’ are from a single node then the bigram t_{b}tₐ is selected as the attribute instead of tₐ and similarly the trigram t_{c}t_{b}tₐ is selected as the attribute if ‘b’ has all the inlinks from a single node ‘c’. This helps us in extracting multi-word attributes like “wood construction”, “pitch pipe,” and so forth.

In some embodiments, the extraction of attributes from clusters may be programmed as follows. First, the node with the highest number of incoming edges is selected as a starting point for the attribute. Next, since the attribute can have multiple words in it, like “point type” and “point size”, the outgoing edges of the attribute node are inspected, and the process is programmed to select those words which have significant weight. In experiments, this process yielded a larger number of attributes; for example, using real data for business items, namely pens, “point” had the highest number of incoming edges in the cluster, and among the outgoing edges from “point”, “type” and “size” had significantly high weight. Therefore, the process could output “point type” and “point size” as two attributes for a pen. Once attributes are formed in this manner, the predecessors of “point” will give the attribute value.

In such an embodiment, data cleaning processes also may be used. For example, an embodiment may be programmed to replace the characters [‘/’, ‘(’, ‘)’ ] with spaces as they do not contribute to attribute name and values. Further, after clustering, within each cluster, a fuzzy-matching process may be executed for nodes which have only alphabetic characters followed by merging nodes having a fuzzy-ratio greater than 80%.

To complete extracting attributes and values from clusters, for each cluster, the process may be programmed to sort nodes in decreasing order based on the sum of weights of incoming edges to it, which may be termed the “in weight” for each node. Those nodes which have {in weight>threshold} are selected as the attributes. An example threshold value is 0.5*(max in weight among all nodes in the cluster). To extract attribute values, for each attribute extracted above, the following is executed: Inspect all incoming edges to the attribute, and sort those nodes in decreasing order of the weights of the edge joining that node to the attribute; of those nodes, the ones having {weight>threshold} are selected as attribute-values for that attribute; this threshold is set as (max weight)/15 for now. It can also bet set to a fixed number such as “10”, “20”, etc.

D. Performance evaluation. In an embodiment, the evaluation of the performance of attribute extraction is based on the precision and recall of the attributes that are extracted. For this purpose, the process is programmed to manually create a list of attributes for each product and use the list as a reference for evaluation purposes. Measuring precision and recall is not straightforward. For example, in the phrase “3× optical zoom,” both “zoom” and “optical zoom” could be considered as attributes. Therefore, in an embodiment, the process is programmed to use a full match and partial match. A match is fully correct if the phrase matches completely with a phrase in the reference list. A match is partially correct if the extracted attribute completely contains any of the manually extracted attributes. Furthermore, any attribute that forms a full match or a partial match is considered recalled. For Precision, Full precision and Partial precision may be reported separately.

### 4. Example Prescriptions

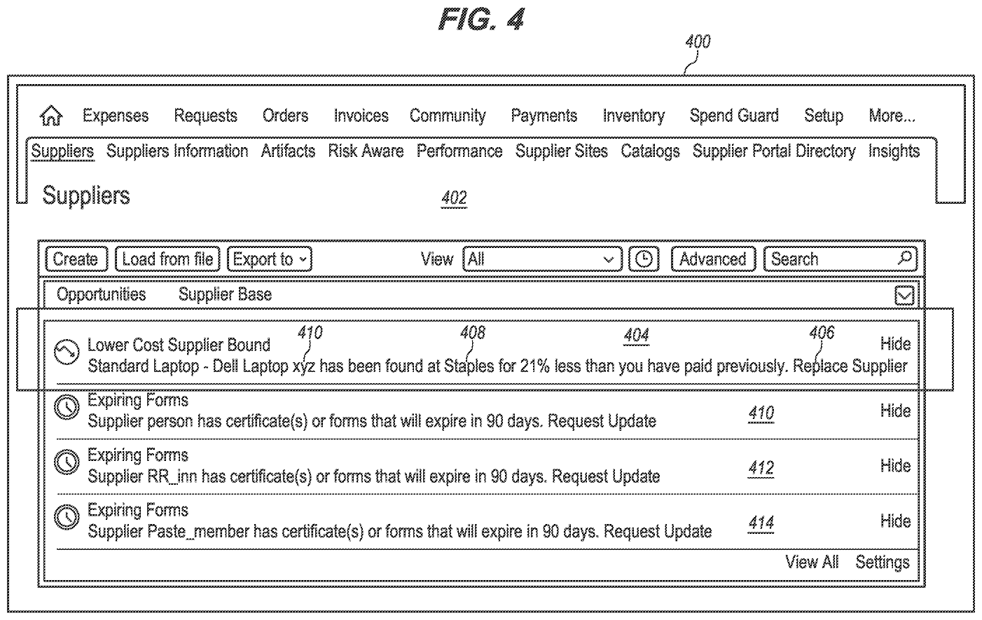

FIG. 4 illustrates an example display device with graphical user interface and showing example prescriptions.

In an embodiment, a Suppliers page 402 may be output to a display device 400 and comprises a plurality of Opportunities alert lines 404, 410, 412, 414. The Suppliers page 402 is output from one of the application instances 102, 104, 106 (FIG. 1) as part of spend management functionality.

In an embodiment, the processes described in other sections herein cause generating alert line 404 concerning a lower cost supplier and inserting that Opportunities alert line into the current account's set of Opportunities alert lines. In one embodiment, statistical processor 112 is programmed to generate and insert, in the Opportunities, alert line 404 identifying a lower cost supplier when the average price of a commodity in a set of past transactions for that commodity, of the presently logged-in user account or the entity with which the account is associated, is greater than one standard deviation or two standard deviations from a median price of the same commodity as indicated in the normal distribution of the entire community of transactions for the same commodity.

Each alert line may comprise a plurality of hyperlinks that are generated automatically as part of the alert line. For example, Opportunities alert line 404 comprises hyperlinks 406, 408, 410. A first hyperlink 406, when selected, causes loading a page of the application instance 102 that enables the current buyer computer or user account to review details concerning the supplier; therefore, the buyer computer can begin a transaction with the new supplier if desired. A second hyperlink 408 identifies the supplier by name and can link to the same page or function of the instance 102 as the first hyperlink 406. A third hyperlink 410 is a normalized commodity identifier which, when selected, causes displaying detailed information about the commodity.

Example of prescriptions that may be output based upon appropriate data include assertions such as:

A. Last year you bought N of this item. This year, prices have been trending up. Based on current pricing trends, you might want to consider: buying early, waiting/staying put, buying less now and more later, switching to substitutes, joining a source together event.

B. There appears to be price breaks in this item, consider consolidating spend into fewer and larger purchases to drive more savings

C. This item's price seems to fluctuate with time of year, consider focusing purchases in the fall/spring/winter/summer to drive more savings.

D. You have bought this item from X different suppliers, that is Y % more than the community. Consider consolidating your spending with your lowest cost supplier Z

E. X % of this item was not purchased with your lowest-cost supplier, consider moving more spend to Y supplier to drive more savings

F. The following suppliers in the Coupa Community offer items similar to this item, consider adding them to a sourcing event maximize future savings.

The position of a buyer computer within the top quartile of the distribution that the statistical processor 112 may drive generating a prescription asserting that the buyer account or its entity are obtaining the lowest price for the specified commodity. Or, the position of the buyer computer within the distribution as a whole could drive generating a prescription asserting that the present is a good time, or poor time, in which to initiate a new contract at the median price or a price near the median price. Or, a prescription may be programmed to assert that if the buyer changes the quantity of the commodity a better price can be obtained. Thus, a prescription is not required to involve price but can concern another attribute of a commodity or transaction.

### 5. Examples of Processing Scale, Result Data, and Criteria for Price Comparison

In an embodiment, experimental execution processed three (3) years of data having the following attributes:

| DATA TYPE | QUANTITY |
|---|---|
| # of requisition lines (‘approved’, ‘ordered’, ‘received’, ‘partially_received’, | 177,577,873 |
| ‘backgrounded’) | |
| # of requisition headers (‘approved’, ‘ordered’, ‘received’, ‘partially_received’, | 61,798,975 |
| ‘backgrounded’) | |
| # of approved invoice lines | 230,040,815 |
| # of approved invoice headers | 97,249,197 |
| # of suppliers | 2,097,226 |
| # of normalized suppliers | 1,466,824 |

Another experimental execution processed six months of data having the following attributes:

| DATA TYPE | QUANTITY |
|---|---|
| # of requisition lines (‘approved’, ‘ordered’, ‘received’, ‘partially_received’, | 33,361,331 |
| ‘backgrounded’) | |
| # of invoice lines | 51,901,297 |
| # of order lines with req | 33,355,266 |
| # of suppliers associated with any of reqs | 991,286 |
| # of normalized suppliers associated with any of req, po, invoice | 730,192 |
| # of items associated with reqs | 971,922 |
| # of requisition lines that has manufacturer_part_number | 4,133,411 |
| # of requisition lines that has manufacturer_part_number | 2,178,348 |
| that was purchased with another supplier | |
| and within community price range | |
| # of requisition lines with item id | 10,647,633 |
| # of requisition lines by catalog id | 1,756,493 |
| # of requisition lines by catalog id w manufacturer_part_number | 31,853 |

In one experiment, using analysis through the attribute requisition_line.manufacturer_part_number, the following results were obtained:

| DATA TYPE | QUANTITY |
|---|---|
| # of requisition lines that we found cheaper price by another supplier within | 527,314 |
| last 6 month | |
| # of requisition lines that we found cheaper price by another supplier in the | 88,526 |
| same month | |
| unique mpn from requisitions with mpn more than 4 chars | 850,708 |
| unique mpn from requisitions with alpha numeric | 326,597 |

Experiments with available computing hardware showed approximate performance of four (4) hours to extract all attributes from 44 million rows of data, or about 166,000 rows per minute. Extraction yielded values for manufacturer part number, manufacturer name, and others. Example results included:

| DATA TYPE | QUANTITY |
|---|---|
| Number of requisition lines extracted attributes from | 141950580 |
| Number of items table extracted attributes (entire items table) | 37079 |
| Number of req line rows that MPN extracted from description | 1141546 |
| Number of req line rows that MPN extracted from description or item | 1349013 |
| description | |
| Total number of req line in US region with MPN | 2579166 (1.8%) |
| Number of req line rows with Brand (manufacturer name) extracted | 27725837 (19.5%) |
| Number of req line rows with model attribute extracted (only for paper, | 843410 |
| toner, pen) | |
| Number of req line rows with size attribute extracted(only for paper, toner, | 2022614 |
| pen) | |
| Number of req line rows with color attribute extracted (only for paper, | 12593338 |
| toner, pen) | |

In experiments, once the foregoing data is processed to identify spend lines comprising comparable commodities, price variance may be calculated at block 226 (FIG. 2B) by eliminating outlier values, such as the lowest-priced and highest-priced spend line, then calculating a normal distribution of price values represented in the spend lines. Based on any attribute and with an interquartile range, the process may be programmed to determine an amount of difference in all prices contained in the remaining spend lines. A small interquartile range indicates good grouping of prices and likely the median will be the target price that the buyer computer should receive as a recommendation or as a basis of prescriptions.

Experiments further have demonstrated that the techniques used for fuzzy matching of commodity descriptions among spend lines will have a significant effect on the accuracy of price variance calculations. Programmatic normalization techniques at block 226 or block 224 can reduce the error rate in matching. For example, a value of “8.5×11” should be processed programmatically as equivalent to “8½×11” for the purpose of matching. In other cases, it may be possible to program rules for automatically generating terms in a taxonomy based on other keywords that appear in a spend line. In still other cases, comparison based on an existing UNSPSC code or supplier part number may yield the best results.

In an experimental embodiment, processing data from third-party data sources has identified an association between selected attributes and price differentiation. For example, item listings at AMAZON.COM may include a SIZE attribute and products of different sizes usually have different prices. Furthermore, the SIZE attribute in AMAZON.COM does not comprise a discrete value but includes multiple other metadata values that bear on price. Examples include number of units, weights, dimension information and so forth, all of which may differentiate prices. At block 226, the process may be programmed to obtain these data values and use them in calculations of price similarity.

In an embodiment, the “Compare with similar items” function of third-party data sources may be read at block 226 to identify other attributes that are important for price comparison. For example, AMAZON.COM provides a comparison feature in which a display of a particular product always includes a plurality of other products that algorithms of AMAZON consider to be similar to the particular product. These algorithms can group similar items based on critical attributes but still show enough variance to induce alternative means of purchase. Examples include different organizational methods for products, different packaging, and different unit count within multi-unit products. Reading the attributes specified in comparative products, via this function, can yield attribute values that indicate price variance.

In an embodiment, data tables in commercial website product displays may also include attributes of products and may be read at block 226 to derive similar pricing. For example, AMAZON.COM provides a table feature showing all attributes of the product when a particular product is selected for display. Each attribute identified in the table may be deemed to be influential on price variance. In various embodiments, the processes of this disclosure may be programmed to apply different strictness criteria to the attributes.

In an embodiment, block 226 is programmed to automatically determine critical attributes of an item or commodity based on the foregoing data sources or others. In an embodiment, a third-party website, catalog, or other data source is read, or scraped, for ten (10) instances of specific products for each UNSPSC Code level 4, and attributes are obtained from the sample and stored as the critical attributes for the specified product. In an embodiment, the techniques described in “How to Scrape Amazon Product Details Using Python 3,” available online at the domain scrapehero.com on the worldwide web. In some embodiments, unit types such as Box, Carton, or Case may be extracted. In other embodiments, a master manufacturer part number can be obtained programmatically using API calls to a retailer or distributor API. An example is the Walmart API, which can respond with MPN (modelNumber) as well as UPC, via calls to the endpoint api.walmartlabs.com.

Even when these techniques are used, excessive and non-useful price variance may occur when catalog or website data includes products that are described in a generally similar manner but represent extremely different quantities or unit size. An example is the identical paper product that is offered in the unit of a Ream, and also in a Pallet of 40 cases each containing 10 reams. Therefore, the unit of measure at the order level of the data described above may have a price range that is not useful for comparison. This issue may be programmatically addressed using a commodity classifier or filter to limit spend lines by specified size values. In one embodiment, block 226 is programmed to execute an item similarity routine as follows:

A. Filter out specified transactions, such as approved requisition lines in the last three years, to yield a relevant dataset.

B. Classify transactions to item

C. Extract Attributes and normalize attributes

D. Calculate Price distribution of this item and remove outliers

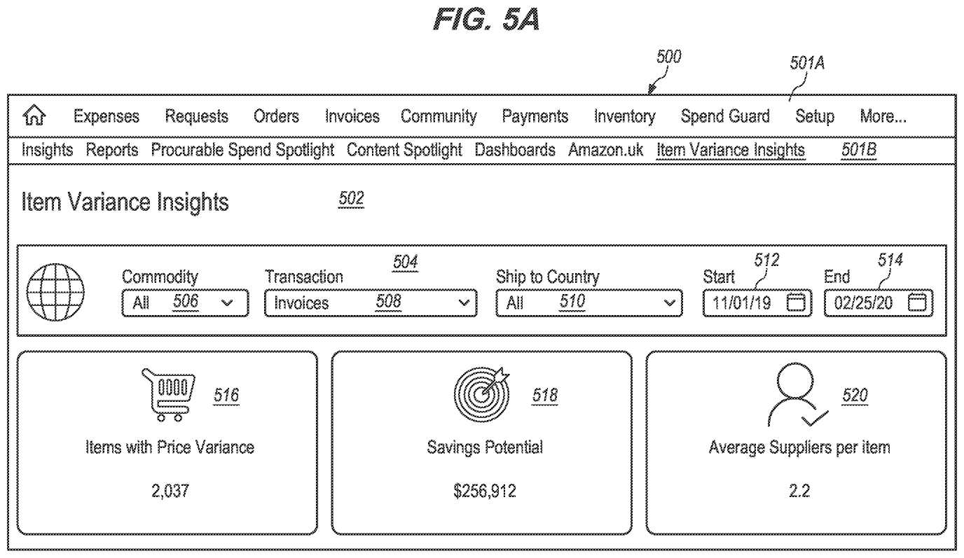

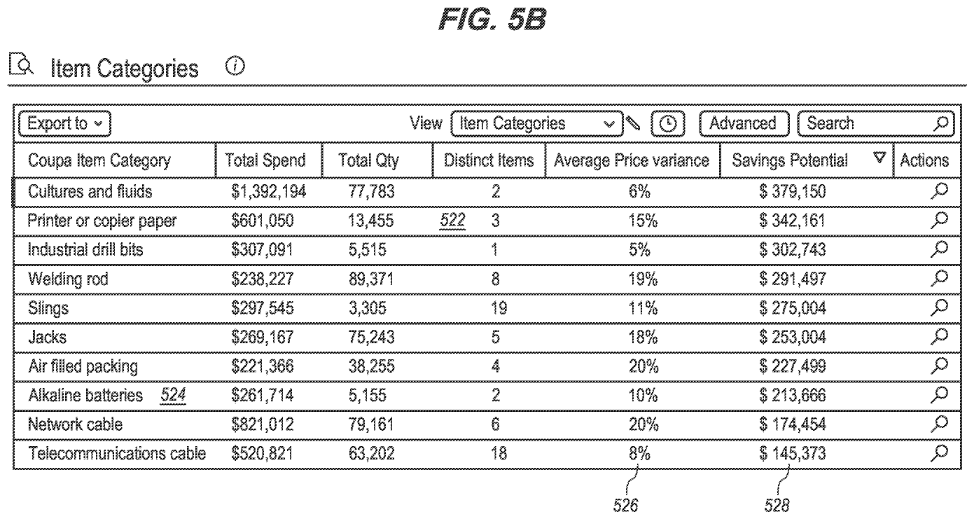

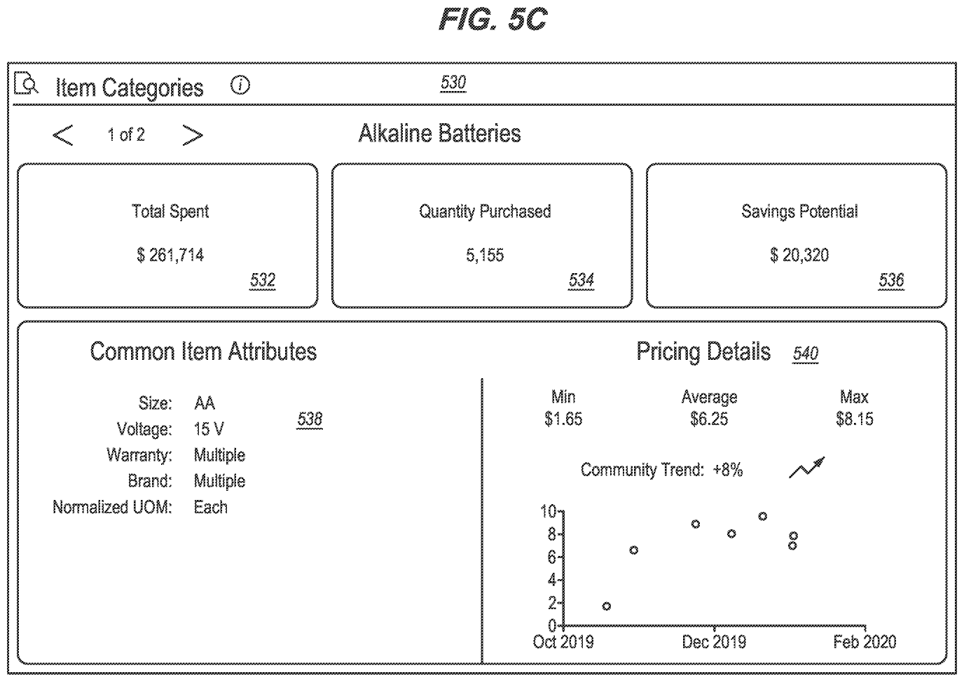

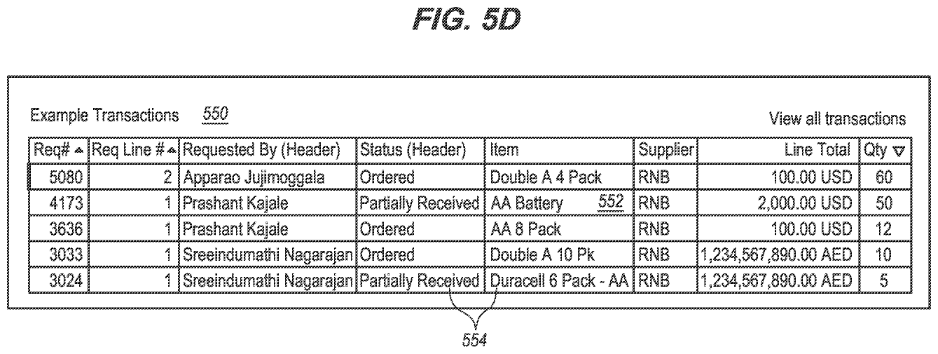

When price variance values have been determined, then block 228 of FIG. 2B or presentation processor 114 of FIG. 1 may be programmed to output price variance data and other analytical data for rendering and display using the end-user device 116, for example, in a graphical user interface. FIG. 5A illustrates an example display device with graphical user interface showing item price variance data and related values. In an embodiment, an output page 500 of one of the application instances 102, 104, 106 may comprise an Item Variance Insights panel 502 having a filter toolbar 504 and metrics displays 516, 518, 520. The page 500 may also include a function toolbar 501A comprising hyperlinks for selecting highest-level functions of an instance 102, and a spend insights toolbar 501B comprising hyperlinks for selecting second-level functions of the instance. The specific functions of these toolbars are beyond the scope of this disclosure but in general, the hyperlinks may be organized in a hierarchy such as selecting a first hyperlink in toolbar 501A and an Item Variance Insights hyperlink in toolbar 501B causes the instance 102 to generate and display the Item Variance Insights panel 502.

In the example of FIG. 5A, filter toolbar 504 comprises a Commodity widget 506, Transaction widget 508, Ship-to widget 510, Start date widget 512, and End date widget 514. Each of the widgets 506, 508, 510, 512, 514 may comprise a selectable graphical element which, when selected, causes automatically re-calculating data for the metrics displays 516, 518, 520 and updating their values. Thus, the widgets 506, 508, 510, 512, 514 may comprise active filters that can be selected and transmit signals to the application instance 102 to cause the instance to recalculate data and transmit updated data for display.

In an embodiment, each of the metrics displays 516, 518, 520 may comprise a hyerlink and may include the following, although other embodiments may show other metrics. In an embodiment, metric display 516 specifies a count of items showing price variance. The item count may comprise items that the same buyer account previously purchased that show a significant price variance in comparison to community data for transactions with suppliers that the buyer account is not using. For example, metric display 516 may include a count of all items in transactions of the buyer account having prices that vary by more than 5% from a previously calculated median price for the same commodity as in the transactions. The threshold here of 5% is merely an example and other embodiments may use any other threshold such as 10%, one or two standard deviations from the median, etc.

Metric display 518 specifies a savings potential comprising a total amount of currency or value that would have been saved if the items shown in metric display 516 had been purchased from known lower-cost suppliers in the community. In one embodiment, the amount displayed with metric display 518 is the product of the items counted in metric display 516 and the median prices of those commodities. Metric display 520 specifies an average number of suppliers per item that other buyers in the community are using.

FIG. 5B illustrates an example display device with graphical user interface showing example item categories. In one embodiment, the display of FIG. 5B is generated and rendered in response to input from a buyer computer indicating a selection of metric display 516 of FIG. 5A.

In an embodiment, the display of FIG. 5B comprises an item category table 522 comprising a plurality of rows, each of which specifies data for a particular item category. Each row comprises a plurality of columns specifying values for item category attributes. In an embodiment, each row includes an average price variance column 526 and a savings potential column 528 that display output calculations of the processes herein to show the variance in price of historic transactions in commodities in the category represented by the row, in comparison to other transactions for commodities in the same category conducted by other buyer computers. In an embodiment, the average price variance column 526 specifies variance as a percentage difference of an average price represented in the buyer account's past transactions for a commodity in comparison to the median price of the community in all past transactions of the community for the same commodity. In an embodiment, the savings potential column 528 shows the product of the quantity purchased times the difference between the total spent and the total that would have been spent at lower prices that have been found in price variance calculations as previously described.

FIG. 5C illustrates an example display device with graphical user interface showing example variance analysis displays for a single commodity. In an embodiment, the display of FIG. 5C may be generated and rendered in response to an input signal from a buyer computer specifying a selection of one of the rows of table 522 of FIG. 5B. For example, assume that row 524 showing Alkaline Batteries is selected.

FIG. 5C shows an example of variances in prices and other attributes of a particular commodity, such as Alkaline Batteries. FIG. 5C specifically comprises an Item Details panel 530 corresponding to row 524 of FIG. 5B. In the example of FIG. 5C, a total spent panel 532 specifies the total amount that the buyer computer has spent on the item based on historic transactions; a quantity panel 534 specifies the total quantity purchased based on historic data; and a savings potential panel 536 specifies a savings potential expressed as the product of the quantity purchased times the difference between the total spent and the total that would have been spent at lower prices that have been found in price variance calculations as previously described.

In an embodiment, a common item attributes panel 538 specifies values of common attributes of the commodity that were used to identify past similar transactions in historic data. In an embodiment, a pricing details panel 540 specifies minimum, average, and maximum prices that appear in historic data across a large community of all buyer accounts that are associated with a particular one or more of instances 102, 104, 106. In some embodiments, a trend value may be calculated and displayed to indicate whether average price is rising or falling.

FIG. 5D illustrates an example display device with graphical user interface showing example historic transaction data. In one embodiment, a total spent panel 532 of FIG. 5C may be associated with a hyperlink which, when selected, causes generating and rendering the display of FIG. 5D. In an embodiment, FIG. 5D comprises an example transactions table 550 comprising a plurality of rows 552 each comprising a plurality of column attributes 554. Each row represents a purchase requisition line item for a transaction in the commodity of FIG. 5C. The example of FIG. 5D shows a subset of all transactions in the historic data.

In various embodiments, the specific column attributes 554 may vary. Typical values include enough information to identify a past transaction, such as requisition number, buyer account, and status; information sufficient to identify the commodity and supplier; and information sufficient to identify the purchase amount and quantity. These values enable a buyer account to inspect the historic transaction data to confirm that savings could have been realized or to review values that could indicate why a more competitive supplier was not chosen or could be chosen.

### 6. Implementation Example—Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

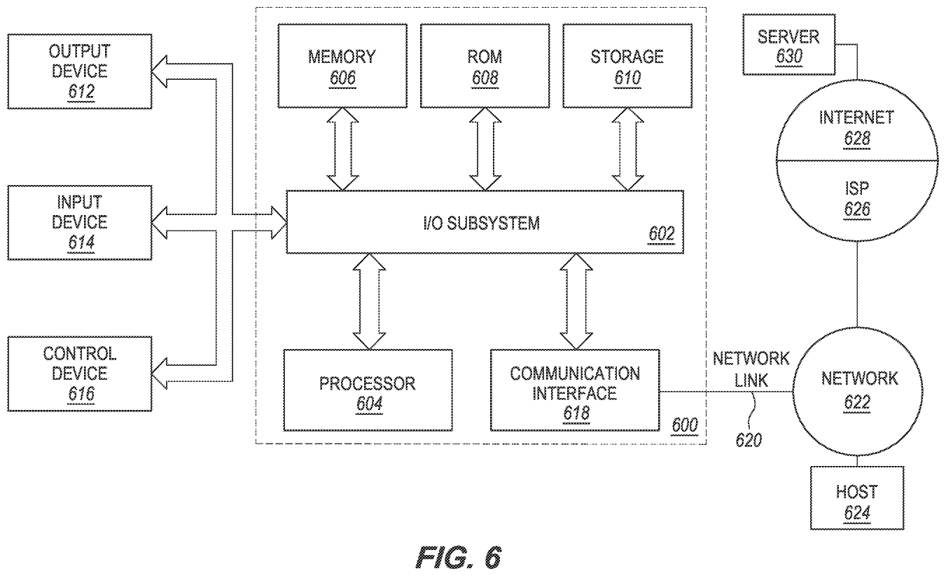

FIG. 6 is a block diagram that illustrates an example computer system with which an embodiment may be implemented. In the example of FIG. 6, a computer system 600 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 600 includes an input/output (I/O) subsystem 602 which may include a bus and/or other communication mechanism(s) for communicating information and/or instructions between the components of the computer system 600 over electronic signal paths. The I/O subsystem 602 may include an I/O controller, a memory controller and at least one I/O port. The electronic signal paths are represented schematically in the drawings, for example as lines, unidirectional arrows, or bidirectional arrows.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system or a graphics processing unit (GPU) or a digital signal processor or ARM processor. Processor 604 may comprise an integrated arithmetic logic unit (ALU) or may be coupled to a separate ALU.

Computer system 600 includes one or more units of memory 606, such as a main memory, which is coupled to I/O subsystem 602 for electronically digitally storing data and instructions to be executed by processor 604. Memory 606 may include volatile memory such as various forms of random-access memory (RAM) or other dynamic storage device. Memory 606 also may be used for storing temporary variables or other intermediate information during execution of instructions to be executed by processor 604. Such instructions, when stored in non-transitory computer-readable storage media accessible to processor 604, can render computer system 600 into a special-purpose machine that is customized to perform the operations specified in the instructions.

Computer system 600 further includes non-volatile memory such as read only memory (ROM) 608 or other static storage device coupled to I/O subsystem 602 for storing information and instructions for processor 604. The ROM 608 may include various forms of programmable ROM (PROM) such as erasable PROM (EPROM) or electrically erasable PROM (EEPROM). A unit of persistent storage 610 may include various forms of non-volatile RAM (NVRAM), such as FLASH memory, or solid-state storage, magnetic disk or optical disk such as CD-ROM or DVD-ROM and may be coupled to I/O subsystem 602 for storing information and instructions. Storage 610 is an example of a non-transitory computer-readable medium that may be used to store instructions and data which when executed by the processor 604 cause performing computer-implemented methods to execute the techniques herein.

The instructions in memory 606, ROM 608 or storage 610 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 600 may be coupled via I/O subsystem 602 to at least one output device 612. In one embodiment, output device 612 is a digital computer display. Examples of a display that may be used in various embodiments include a touch screen display or a light-emitting diode (LED) display or a liquid crystal display (LCD) or an e-paper display. Computer system 600 may include other type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators or servos.

At least one input device 614 is coupled to I/O subsystem 602 for communicating signals, data, command selections or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. Control device 616 may be a touchpad, a mouse, a trackball, or cursor direction keys for communicating direction information and command selections to processor 604 and for controlling cursor movement on display 612. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 614 may include a combination of multiple different input devices, such as a video camera and a depth sensor.

In another embodiment, computer system 600 may comprise an internet of things (IoT) device in which one or more of the output device 612, input device 614, and control device 616 are omitted. Or, in such an embodiment, the input device 614 may comprise one or more cameras, motion detectors, thermometers, microphones, seismic detectors, other sensors or detectors, measurement devices or encoders and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware and interfaces for generating position reporting packets, notifications, pulse or heartbeat signals, or other recurring data transmissions that specify a position of the computer system 600, alone or in combination with other application-specific data, directed toward host 624 or server 630.

Computer system 600 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 600 in response to processor 604 executing at least one sequence of at least one instruction contained in main memory 606. Such instructions may be read into main memory 606 from another storage medium, such as storage 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 602. Transmission media can also take the form of acoustic or light waves, such as those generated during radio-wave and infra-red data communications.

Various forms of media may be involved in carrying at least one sequence of at least one instruction to processor 604 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 600 can receive the data on the communication link and convert the data to a format that can be read by computer system 600. For instance, a receiver such as a radio frequency antenna or an infrared detector can receive the data carried in a wireless or optical signal and appropriate circuitry can provide the data to I/O subsystem 602 such as place the data on a bus. I/O subsystem 602 carries the data to memory 606, from which processor 604 retrieves and executes the instructions. The instructions received by memory 606 may optionally be stored on storage 610 either before or after execution by processor 604.

Computer system 600 also includes a communication interface 618 coupled to bus 602. Communication interface 618 provides a two-way data communication coupling to network link(s) 620 that are directly or indirectly connected to at least one communication networks, such as a network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 622 broadly represents a local area network (LAN), wide-area network (WAN), campus network, internetwork or any combination thereof. Communication interface 618 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may provide a connection through a network 622 to a host computer 624.

Furthermore, network link 620 may provide a connection through network 622 or to other computing devices via internetworking devices and/or computers that are operated by an Internet Service Provider (ISP) 626. ISP 626 provides data communication services through a world-wide packet data communication network represented as internet 628. A server computer 630 may be coupled to internet 628. Server 630 broadly represents any computer, data center, virtual machine or virtual computing instance with or without a hypervisor, or computer executing a containerized program system such as DOCKER or KUBERNETES. Server 630 may represent an electronic digital service that is implemented using more than one computer or instance and that is accessed and used by transmitting web services requests, uniform resource locator (URL) strings with parameters in HTTP payloads, API calls, app services calls, or other service calls. Computer system 600 and server 630 may form elements of a distributed computing system that includes other computers, a processing cluster, server farm or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 630 may comprise a web application server that hosts a presentation layer, application layer and data storage layer such as a relational database system using structured query language (SQL) or no SQL, an object store, a graph database, a flat file system or other data storage.

Computer system 600 can send messages and receive data and instructions, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage 610, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method, comprising:
establishing programmatic connections of a programmed computer system to a plurality of application instances comprising data of over a million transactions, the transactions comprising transaction descriptions and commodities involved in the transactions, the commodities having item attributes;
executing, using the programmed computer system:
normalizing transaction descriptions and determining item attributes for a plurality of the commodities by accessing a plurality of different digitally stored buying data sources including two or more of digital catalogs, punchouts, and external sources, taxonomy data, community transactions data, and an item attribute library;
extracting and storing the item attributes in item sets, without access to a priori digitally stored data that describes the attributes, by executing BIOE sequence tagging via a machine learning model that has been trained to tag each word as BIOE for each attribute simultaneously and comprising a word embedding layer coupled to a BiLSTM (Bidirectional Long Short Term Memory) layer, a Conditional Random Fields (CRF) layer following the BiLSTM layer, and an attention mechanism, the BiLSTM layer comprising one or more LSTM models that capture a sequential nature of tokens apart from a sequential nature of tags, the CRF layer being implemented to enforce tagging consistency and extract cohesive chunks of attribute values;
based on the item sets, grouping similar items and executing statistical price comparison calculations on the item sets and outputting one or more prescriptions, at least one of the prescriptions specifying a community trend in a price of a particular commodity among the plurality of the commodities across all the application instances;
using the programmed computer system, generating presentation instructions which when rendered using a computer display device cause displaying one or more graphical visualizations of the prescriptions in a graphical user interface of the computer display device.

2. The method of claim 1, the attention mechanism being implemented to identify, from among a plurality of states that the BiLSTM layer generates, states that may be more important than others in the CRF layer making predictions.

3. The method of claim 1, the executing the normalizing transaction descriptions further comprising automatically creating and storing a taxonomy of items via graph construction, clustering, extraction of attributes from clusters, and performance evaluation.

4. The method of claim 1, the data for transactions of one entity associated with a first application instance among the plurality of application instances being logically isolated from and inaccessible to a second, different entity that is associated with a second application instance among the plurality of application instances.

5. The method of claim 1, the item attributes comprising line spend values, unit price values, quantity values, and buyer country data.

6. The method of claim 1, the programmed computer system being a distributed, multiple instance, multiple tenant, spend management computer system with which a plurality of buyer computers and supplier computers are communicatively coupled and execute transactions.

7. The method of claim 6, further comprising:
executing the statistical price comparison calculations on the item sets to calculate a total amount that a buyer entity associated with the particular buyer computer has spent on a particular commodity based on historic transactions, a total quantity purchased by the buyer entity based on historic data, and a savings potential expressed as a product of the quantity purchased times a difference between the total spent and a total that would have been spent at lower prices that have been found in price variance calculations;
generating the presentation instructions which when rendered using the computer display device cause displaying, in the graphical user interface of a particular buyer computer among the plurality of buyer computers, an item detail panel comprising a total spent panel that specifies the total amount that the buyer entity associated with the particular buyer computer has spent on the particular commodity based on historic transactions, a quantity panel that specifies the total quantity purchased by the buyer entity based on historic data, and a savings potential panel that specifies the savings potential.

8. The method of claim 7, further comprising causing displaying, in the item detail panel, values of common attributes of the particular commodity that were used to identify the past similar transactions in the historic data.

9. The method of claim 8, further comprising:
executing the statistical price comparison calculations on the item sets to calculate minimum, average, and maximum prices that appear in historic data across all buyer accounts that are associated with a particular one or more of the application instances;
generating the presentation instructions which when rendered using the computer display device cause displaying, in the graphical user interface, the item detail panel further comprising a pricing details panel that specifies minimum, average, and maximum prices that appear in historic data across all buyer accounts that are associated with a particular one or more of the application instances.

10. The method of claim 8, further comprising:
executing the statistical price comparison calculations on the item sets to calculate a trend value to indicate whether average price is rising or falling;
generating the presentation instructions which when rendered using the computer display device cause displaying, in the graphical user interface, the item detail panel specifying the trend value to indicate whether average price is rising or falling.

11. The method of claim 1, further comprising:
executing the statistical price comparison calculations on the item sets to calculate a trend value to indicate whether average price is rising or falling;
generating the presentation instructions which when rendered using the computer display device cause displaying, in the graphical user interface, the item detail panel specifying the trend value to indicate whether average price is rising or falling.

13. One or more non-transitory computer-readable storage media storing one or more sequences of stored program instructions which, when executed using one or more processors, cause the one or more processors to execute:
establishing programmatic connections of a programmed computer system to a plurality of application instances comprising data of over a million transactions, the transactions comprising transaction descriptions and commodities involved in the transactions, the commodities having item attributes;
executing, using the programmed computer system:
normalizing transaction descriptions and determining item attributes for a plurality of the commodities by accessing a plurality of different digitally stored buying data sources including two or more of digital catalogs, punchouts, and external sources, taxonomy data, community transactions data, and an item attribute library;
extracting and storing the item attributes in item sets, without access to a priori digitally stored data that describes the attributes, by executing BIOE sequence tagging via a machine learning model that has been trained to tag each word as BIOE for each attribute simultaneously and comprising a word embedding layer coupled to a BiLSTM (Bidirectional Long Short Term Memory) layer, a Conditional Random Fields (CRF) layer following the BiLSTM layer, and an attention mechanism, the BiLSTM layer comprising one or more LSTM models that capture a sequential nature of tokens apart from a sequential nature of tags, the CRF layer being implemented to enforce tagging consistency and extract cohesive chunks of attribute values;
based on the item sets, grouping similar items and executing statistical price comparison calculations on the item sets and outputting one or more prescriptions, at least one of the prescriptions specifying a community trend in a price of a particular commodity among the plurality of the commodities across all the application instances;
using the programmed computer system, generating presentation instructions which when rendered using a computer display device cause displaying one or more graphical visualizations of the prescriptions in a graphical user interface of the computer display device.

14. The non-transitory computer-readable storage media of claim 13, the attention mechanism being implemented to identify, from among a plurality of states that the BiLSTM layer generates, states that may be more important than others in the CRF layer making predictions.

15. The non-transitory computer-readable storage media of claim 13, the executing the normalizing transaction descriptions further comprising automatically creating and storing a taxonomy of items via graph construction, clustering, extraction of attributes from clusters, and performance evaluation.

16. The non-transitory computer-readable storage media of claim 13, the data for transactions of one entity associated with a first application instance among the plurality of application instances being logically isolated from and inaccessible to a second, different entity that is associated with a second application instance among the plurality of application instances.

17. The non-transitory computer-readable storage media of claim 13, the item attributes comprising line spend values, unit price values, quantity values, and buyer country data.

18. The non-transitory computer-readable storage media of claim 13, the programmed computer system being a distributed, multiple instance, multiple tenant, spend management computer system with which a plurality of buyer computers and supplier computers are communicatively coupled and execute transactions.

19. The non-transitory computer-readable storage media of claim 18, further comprising:
executing the statistical price comparison calculations on the item sets to calculate a total amount that a buyer entity associated with the particular buyer computer has spent on a particular commodity based on historic transactions, a total quantity purchased by the buyer entity based on historic data, and a savings potential expressed as a product of the quantity purchased times a difference between the total spent and a total that would have been spent at lower prices that have been found in price variance calculations;
generating the presentation instructions which when rendered using the computer display device cause displaying, in the graphical user interface of a particular buyer computer among the plurality of buyer computers, an item detail panel comprising a total spent panel that specifies the total amount that the buyer entity associated with the particular buyer computer has spent on the particular commodity based on historic transactions, a quantity panel that specifies the total quantity purchased by the buyer entity based on historic data, and a savings potential panel that specifies the savings potential.

20. The non-transitory computer-readable storage media of claim 19, further comprising causing displaying, in the item detail panel, values of common attributes of the particular commodity that were used to identify the past similar transactions in the historic data.

21. The non-transitory computer-readable storage media of claim 19, further comprising:
executing the statistical price comparison calculations on the item sets to calculate minimum, average, and maximum prices that appear in historic data across all buyer accounts that are associated with a particular one or more of the application instances;
generating the presentation instructions which when rendered using the computer display device cause displaying, in the graphical user interface, the item detail panel further comprising a pricing details panel that specifies minimum, average, and maximum prices that appear in historic data across all buyer accounts that are associated with a particular one or more of the application instances.

22. The non-transitory computer-readable storage media of claim 19, further comprising:
executing the statistical price comparison calculations on the item sets to calculate a trend value to indicate whether average price is rising or falling;
generating the presentation instructions which when rendered using the computer display device cause displaying, in the graphical user interface, the item detail panel specifying the trend value to indicate whether average price is rising or falling.

23. The non-transitory computer-readable storage media of claim 13, further comprising:
executing the statistical price comparison calculations on the item sets to calculate a trend value to indicate whether average price is rising or falling;
generating the presentation instructions which when rendered using the computer display device cause displaying, in the graphical user interface, the item detail panel specifying the trend value to indicate whether average price is rising or falling.
